(19) United States
(12) Patent Application Publication
(10) Pub. No.: US 2006/0102428 A1
(43) Pub. Date: May 18, 2006

(54) Lubrication apparatus

(75) Inventors: Shigeru Anada, Toyota-shi (JP); Makoto Shirai, Toyohashi-shi (JP)

Correspondence Address: REED SMITH LLP;Suite 1400, 3110 Fairview Park Drive, Falls Church, VA, 22042, US

(73) Assignee: Aisin Seiki Kabushiki Kaisha

(21) Appl. No.: 11/264,009

(22) Filed: Nov. 2, 2005

(30) Foreign Application Priority Data
Nov. 15, 2004 (JP) 2004-330937

(51) Int. Cl. F16N 29/00

(52) U.S. Cl. 184/6

(57) ABSTRACT

A lubrication apparatus includes a first pump of roots type for feeding oil into an oil tank and a second pump of external gear type for feeding the oil stored in the oil tank to a position where the oil is supplied. The first pump and the second pump are rotatably driven by a drive shaft which is commonly used for the first and second pumps.

### CROSS REFERENCE TO RELATED APPLICATIONS

This application is based on and claims priority under 35 U.S.C. § 119 to Japanese Patent Application 2004-330937, filed on Nov. 15, 2004, the entire content of which is incorporated herein by reference.

### FIELD OF THE INVENTION

The present invention generally relates to a lubrication apparatus. More particularly, the present invention pertains to a lubrication apparatus including a first pump for feeding oil into an oil tank and a second pump for feeding oil stored in the oil tank to a position where the oil is supplied.

### BACKGROUND

Conventionally, a dry sump type lubrication apparatus described in JP2001-73731A is known. The lubrication apparatus includes a scavenge pump of internal gear type for feeding an oil gathered at a lower portion of an engine into an oil tank and a feed pump of internal gear type for feeding an oil stored in the oil tank to certain portion(s) of the engine.

Such apparatus requires a driving means for separately driving the scavenge pump and the feed pump, which results in upsize of the apparatus. Further, because the scavenge pump is an internal gear type, the amount of ejection per one cycle of the pump is small. Further, because the gears contact each other, friction between the gears tends to be increased, which results in loss of driving force.

A need thus exists for a downsized lubrication apparatus having a large amount of ejection per one cycle of a pump in which friction between gears is reduced.

### SUMMARY OF THE INVENTION

According to an aspect of the present invention, a lubrication apparatus includes a first pump of roots type for feeding oil into an oil tank, a second pump of external gear type for feeding oil stored in the oil tank into a position where the oil is supplied, and a drive shaft commonly utilized for operating the first pump and the second pump.

According to a further aspect of the present invention, a lubrication apparatus includes a first pump of roots type for feeding oil into an oil tank, the first pump including a case, a drive shaft rotatably provided at the case through a first bearing, a first rotor fixed to the drive shaft, a driven shaft rotatably provided at the case through a second bearing, and a second rotor fixed to the driven shaft, and a second pump of external gear type for feeding the oil stored in the oil tank to a position where the oil is supplied, the second pump including the case commonly utilized with the first pump, the drive shaft commonly utilized with the first pump and rotatably provided at the case through the first bearing, a first gear fixed to the drive shaft, the driven shaft commonly utilized with the first pump and rotatably provided at the case through the second bearing, and a second gear fixed to the driven shaft. The first and second gears have a function for synchronizing rotational phases between first and second rotors of the first pump.

### BRIEF DESCRIPTION OF THE DRAWINGS

The foregoing and additional features and characteristics of the present invention will become more apparent from the following detailed description considered with reference to the accompanying drawings, wherein:

FIG. 1 represents a schematic diagram according to an embodiment of the present invention;

FIG. 2 represents a cross-sectional view of a lubrication apparatus 100 according to the embodiment of the present invention;

FIG. 3 represents a cross-sectional view taken on line III-III of FIG. 2;

FIG. 4 represents a cross-sectional view taken on line IV-IV of FIG. 2; and

FIG. 5 represents an enlarged view of a part represented by C in FIG. 3.

### DETAILED DESCRIPTION

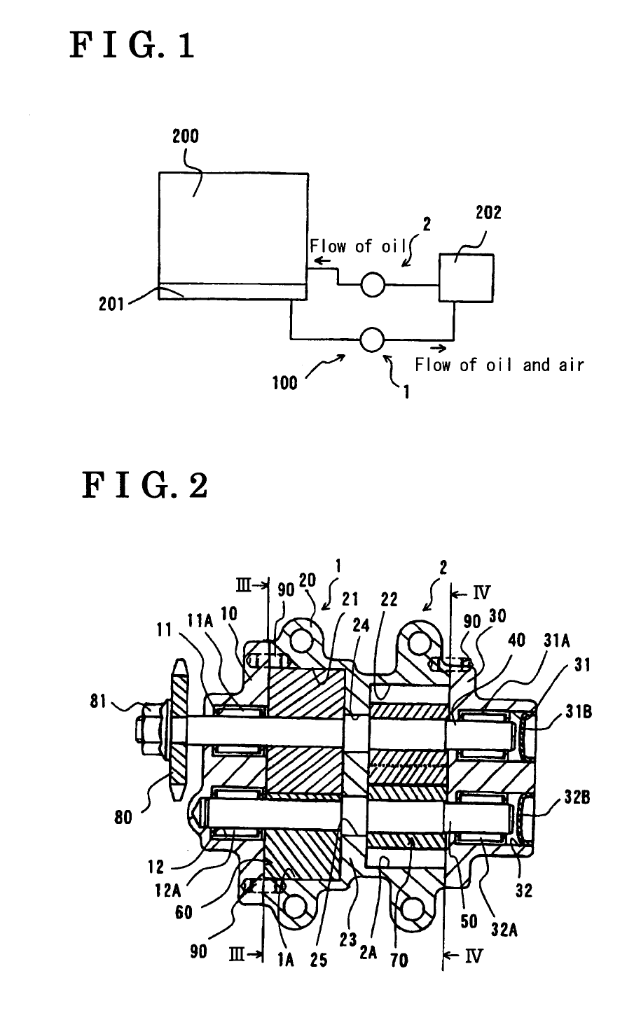

An embodiment of the present invention will be explained with reference to FIGS. 1 to 5.

As illustrated in FIGS. 1 and 2, a lubrication apparatus 100 includes a first pump 1, which is a roots type pump, and a second pump 2, which is an external gear type pump. Both pumps 1 and 2 include a common drive shaft 40. Thus, the both pumps 1 and 2 are connected each other through the drive shaft 40 and operated by the drive shaft 40. The first pump 1 and the second pump 2 correspond to a scavenge pump and a feed pump of a dry sump type lubrication apparatus respectively.

The first pump 1 draws oil and air from a lower portion 201 of an engine 200 and ejects the oil and air to an oil tank 202. The second pump 2 draws oil from the oil tank 202 and ejects the oil to certain portion(s) of the engine (position where the oil is supplied) 200.

As illustrated in FIG. 2, the lubrication apparatus 100 mainly includes a front cover 10, a center case 20, a rear cover 30, a drive shaft 40, a driven shaft 50, a first pump rotor 60, a second pump gear 70 and a sprocket 80.

A stepped through hole 11 and a stepped hole 12 having a bottom are provided at the front cover 10 in parallel. In the stepped through hole 11 and the stepped hole 12, a bearing 11A and a bearing 12A, which are needle bearings, are provided respectively. Utilizing such a needle bearing can reduce a distance between the shafts and contributes to downsize the apparatus.

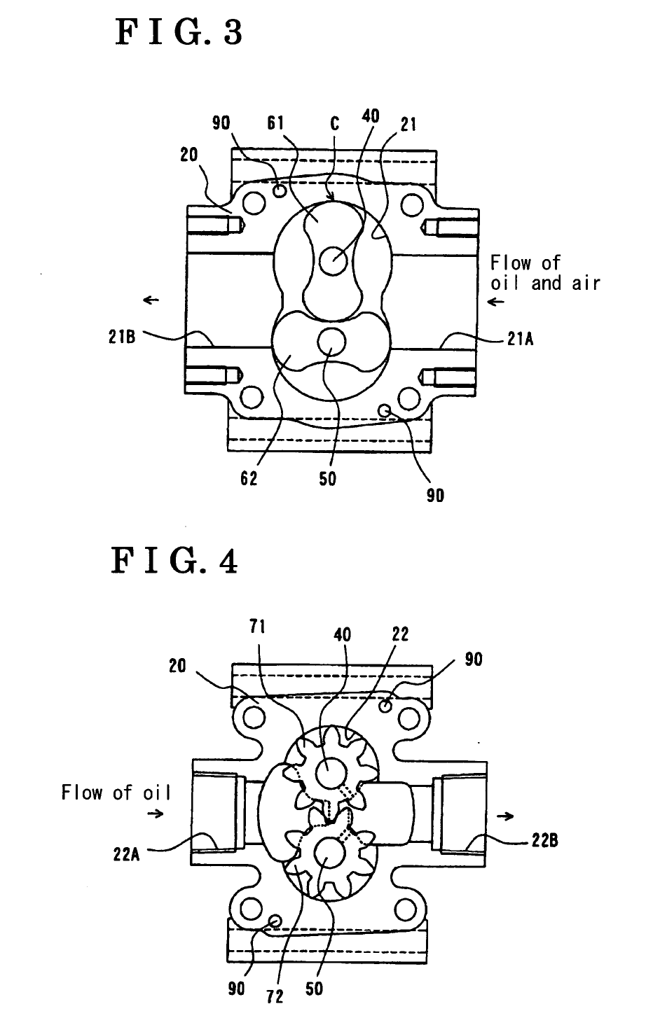

Recessed portions 21 and 22 are provided at both sides of the center case 20 respectively. Each of the recessed portions 21 and 22 includes a cylindrical space with a bottom. A wall portion 23 is provided between the recessed portions 21 and 22. Through holes 24 and 25 are provided at the wall portion 23. The through holes 24 and 25 face the stepped through hole 11 and the stepped hole 12 respectively. As illustrated in FIG. 3, an inlet port 21A and an outlet port 21B of the first pump 1 are provided at the recessed portion 21. The inlet port 21A and the outlet port 21B are provided in a radial direction of the drive shaft 40 and face each other across the drive shaft 40. The inlet port 21A and the outlet port 21B are communicated with the cylindrical space with the bottom in the recessed portion 22. The inlet port 21A is communicated with the lower portion 201 of the engine 200. The outlet port 21B is communicated with to the oil tank 202. As illustrated in FIG. 4, an inlet port 22A and an outlet port 22B of the second pump 2 are provided at the recessed portion 22. The inlet port 22A and the outlet port 22B are provided in a radial direction of the drive shaft 40 and face each other across the drive shaft 40. The inlet port 22A and the outlet port 22B are communicated with the cylindrical space with the bottom in the recessed portion 22. The inlet port 22A is communicated with the oil tank 202. The outlet port 22B is communicated with certain portion(s) of the engine 200.

Stepped through holes 31 and 32 are provided at the rear cover 30. The stepped through holes 31 and 32 face the through holes 24 and 25 respectively. In the stepped through holes 31 and 32, a bearing 31A and a bearing 32A, which are needle bearings, are provided respectively. Lids 31B and 32B are fixed to seal an opening portion of the stepped through holes 31 and 32 hydraulically.

The front cover 10, the center case 20, and the rear cover 30 are positioned and fixed mutually by means of positioning pins 90. The front cover 10 covers an opening portion of the recessed portion 21. Thus, the front cover 10 defines a pump chamber 1A of the first pump 1. The rear cover 30 covers an opening portion of the recessed portion 22. Thus, the rear cover 30 defines a pump chamber 2A of the second pump 2.

The drive shaft 40 is inserted into the stepped through hole 11, the through hole 24 and the stepped through hole 31. Further, the drive shaft 40 is rotatably supported by the bearing 11A and the bearing 31A provided in the stepped through hole 11 and the stepped through hole 31 respectively. The sprocket 80 is fixed to one end of the drive shaft 40 with a nut 81. A rotor 61 of roots type configuring the first pump rotor 60 is fixed to the drive shaft 40 at the position in the recessed portion 21. An external gear 71 configuring the second pump gear 70 is fixed to the drive shaft 40 at the position in the recessed portion 22.

The driven shaft 50 is inserted into the stepped hole 12, the through hole 25 and the stepped through hole 32. Further, the driven shaft 50 is rotatably supported by the bearing 12A and the bearing 32A provided in the stepped hole 12 and the stepped through hole 32 respectively. A rotor 62 of roots type configuring the first pump rotor 60 is fixed to the driven shaft 50 at the position in the recessed portion 21. An external gear 72 configuring the second pump gear 70 is fixed to the driven shaft 50 at the position in the recessed portion 22.

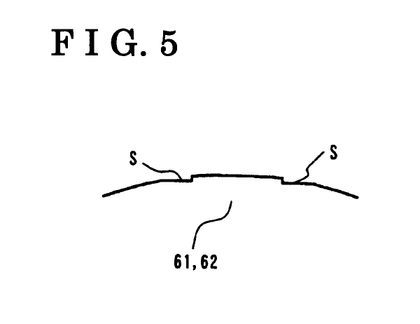

The rotors 61 and 62 are rotatably disposed in the pump chamber 1A. The rotors 61 and 62 does not contact with each other. Oil and air, in other words, oil containing air is drawn from the inlet port 21A and ejected to the outlet port 21B. Cross section of each of the rotors 61 and 62 taken along a surface vertical to the rotational axis has a cocoon shape having two lobes. Each of the cross section of the rotors 61 and 62 may have more than three lobes. The first pump 1 is configured from the pump chamber 1A and the rotors 61 and 62. As illustrated in FIG. 5, a stepped portion S is formed at a periphery of each of the rotors 61 and 62 in axial direction. The stepped portion S sweeps the oil. The clearance around the periphery of each of the rotors 61 and 62 can be sealed by the oil swept by the stepped portion S. Thus, efficiency of the pump can be increased.

In the pump chamber 2A, the outer gears 71 and 72 are rotatably provided. The gears 71 and 72 are engaged with and in contact with each other. The oil is drawn from the inlet port 22A and ejected to the outlet port 22B. Engagement between gears 71 and 72 can determine rotational phases of the rotors 61 and 62 of the first pump 1. Accordingly, the rotors 61 and 62 can be rotated without contacting with each other. The second pump 2 is configured from the second pump chamber 2A and the gears 71 and 72. Incidentally, scissors gears can be employed for the gears 71 and 72 for preventing backlashes between the gears 71 and 72.

Next, operations according to the embodiment will be explained as follows.

The drive shaft 40 is driven by a driver (not illustrated) through the sprocket 80. In accordance with the rotation of the drive shaft 40, the rotor 61 and the gear 71 fixed to the drive shaft 40 are rotated. In accordance with the rotation of the gear 71, the gear 72 engaged with the gear 71 is rotated. In accordance with the rotation of the gear 72, the driven shaft 50 fixed to the gear 72 is rotated. In accordance with the rotation of the driven shaft 50, the rotor 62 fixed to the driven shaft 50 is rotated. Thus, the rotation of the drive shaft 40 can be transmitted to the driven shaft 50. Further, relative rotational phase of the drive shaft 40 with the driven shaft 50 can be ensured.

The rotation of the rotors 61 and 62 of the first pump 1 draws the oil and air from the lower portion 201 of the engine 200 through the inlet port 21A and eject the oil and air into the oil tank 202 through the outlet port 21B.

The oil and air are separated from each other in the oil tank 202. The separated oil is stored in the oil tank.

The rotation of the gears 71 and 72 of the second pump 2 draws the oil from the oil tank 202 through the inlet port 22A and eject the oil to certain portion(s) of the engine 200 through the outlet port 22B.

In addition, an application of the present invention is not limited to a lubrication apparatus utilized for an engine.

According to a first aspect of the present invention, a lubrication apparatus includes a first pump of roots type for feeding oil into an oil tank and a second pump of external gear type for feeding the oil stored in the oil tank to a position where the oil is supplied. The first pump and the second pump are rotatably driven by a drive shaft which is commonly used for the first and second pumps.

According to a second aspect of the present invention, an external gear of the second pump includes synchronizing function in addition to pumping function.

According to a third aspect of the present invention, the first pump includes a rotor having a stepped portion provided at a periphery thereof in axial direction.

According to a fourth aspect of the present invention, a rotational shaft (drive shaft, driven shaft) is rotatably supported by a needle bearing.

According to the first aspect of the present invention, the first pump and the second pump are rotatably driven by the drive shaft which is commonly used for the first and second pumps. The first pump is a roots type pump, and the second pump is an external gear type pump. Accordingly, a driving means for independently driving the first and the second pumps is not required. Therefore, the apparatus can be downsized. Further, employing a roots type pump for the first pump can increase the amount of ejection per one cycle of the pump. Further, employing an external gear type pump for the second pump enables to determine phase of rotation of the roots type pump. Accordingly, a timing gear for determining the phase of the rotation of the roots type pump is not required. Therefore, the apparatus can be downsized and costs can be cut.

According to the second aspect of the present invention, the external gear of the second pump includes synchronizing function in addition to pumping function. Accordingly, the external gear can have both functions for synchronizing the roots type pump, in other words, determining the phase of the rotation of the roots type pump, and for pumping oil to certain portion(s) of an engine, which can contribute to downsize the apparatus and cut costs.

According to the third aspect of the present invention, the first pump includes a rotor having a stepped portion provided at a periphery thereof in axial direction. Accordingly, the oil can be swept by the stepped portion. Thus, clearance around the periphery of the rotor can be sealed by the swept oil, which can contribute to increase efficiency of the pump.

According to the fourth aspect of the present invention, the rotational shaft (drive shaft, driven shaft) is rotatably supported by a needle bearing. Accordingly, the distance between the rotational shafts can be reduced, which can contribute to downsize the apparatus.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A lubrication apparatus comprising:
a first pump of roots type for feeding oil into an oil tank; and
a second pump of external gear type for feeding the oil stored in the oil tank to a position where the oil is supplied, wherein
the first pump and the second pump are rotatably driven by a drive shaft which is commonly used for the first and second pumps.

2. The lubrication apparatus according to claim 1, wherein
an external gear of the second pump includes synchronizing function in addition to pumping function.

3. The lubrication apparatus according to claim 1, wherein
the first pump includes a rotor having a stepped portion provided at a periphery thereof in axial direction.

4. The lubrication apparatus according to claim 1, wherein
the drive shaft is rotatably supported by a needle bearing.

5. The lubrication apparatus according to claim 1, further comprising
a case for accommodating the first pump and the second pump.

6. The lubrication apparatus according to claim 2, wherein
the first pump includes rotors of which rotational phases are synchronized by the synchronizing function.

7. The lubrication apparatus according to claim 4, wherein
the first pump and the second pump include a driven shaft rotatably supported by a needle bearing, the driven shaft commonly used for the first and second pumps and driven by the drive shaft.

8. A lubrication apparatus comprising:
a first pump of roots type for feeding oil into an oil tank, the first pump including a case, a drive shaft rotatably provided at the case through a first bearing, a first rotor fixed to the drive shaft, a driven shaft rotatably provided at the case through a second bearing, and a second rotor fixed to the driven shaft; and
a second pump of external gear type for feeding the oil stored in the oil tank to a position where the oil is supplied, the second pump including the case commonly utilized with the first pump, the drive shaft commonly utilized with the first pump and rotatably provided at the case through the first bearing, a first gear fixed to the drive shaft, the driven shaft commonly utilized with the first pump and rotatably provided at the case through the second bearing, and a second gear fixed to the driven shaft, wherein
the first and second gears have a function for synchronizing rotational phases between first and second rotors of the first pump.

9. The lubrication apparatus according to claim 8, wherein
each of the first and second rotors includes a stepped portion provided at a periphery thereof in axial direction.

10. The lubrication apparatus according to claim 8, wherein
each of first and second bearings is a needle bearing.
